(19) United States
(12) Patent Application Publication
(10) Pub. No.: US 2025/0306752 A1
(43) Pub. Date: Oct. 2, 2025

(54) SYSTEM FOR MODIFYING PROMPT AND METHOD THEREOF

(71) Applicant: SAMSUNG SDS CO., LTD., Seoul (KR)

(72) Inventors: Bo Young PARK, Seoul (KR); Young Hyun CHOI, Seoul (KR); Hoon Ki IM, Seoul (KR); Ji Yeon LEE, Seoul (KR); Da Gun LEE, Seoul (KR); Mi Geon CHO, Seoul (KR)

(73) Assignee: SAMSUNG SDS CO., LTD., Seoul (KR)

(21) Appl. No.: 19/064,033

(22) Filed: Feb. 26, 2025

(30) Foreign Application Priority Data
Mar. 26, 2024 (KR) 10-2024-0041167
May 29, 2024 (KR) 10-2024-0069827

(51) Int. Cl. G06F 3/04883; G06F 40/166

(52) U.S. Cl. CPC G06F 3/04883; G06F 40/166

(57) ABSTRACT

There is provided a system and a method for modifying a prompt, performed by a computing device. The method may comprise displaying a first prompt written by a user in a prompt input area of an answer generation screen displayed on the computing device, replacing a keyboard display area with a prompt modification area and displaying the prompt modification area, in response to a predefined first gesture within the keyboard display area of the answer generation screen, and displaying a second prompt in which the first prompt is modified in the prompt input area, in response to a second gesture for modifying the prompt.

### CROSS-REFERENCE TO RELATED APPLICATIONS

This application claims priority from Korean Patent Application No. 10-2024-0041167 filed on Mar. 26, 2024, Korean Patent Application No. 10-2024-0069827 filed on May 29, 2024, in the Korean Intellectual Property Office, and all the benefits accruing therefrom under 35 U.S.C. 119, the contents of which in its entirety are herein incorporated by references.

### BACKGROUND

### 1. Technical Field

The present disclosure relates to a method and system for modifying a prompt, and more particularly, to a method for easily modifying a prompt through a simple gesture of a user and a system to which the method is applied.

### 2. Description of the Related Art

To increase work productivity using generative artificial intelligence (AI) models, prompting capabilities of individual user are becoming increasingly important. However, most users having low prompt writing capabilities are repeatedly querying, using separate prompt correction services, or reusing existing prompts until they acquire the desired result values, but the methods have in common the inconvenience of generating a large number of tokens, screen transitions, and manipulations.

In addition, the function of setting parameters or conditions that may receive more sophisticated answers, such as randomness of answers and temperature settings, is an area that only professional prompt engineers may perform, and has the disadvantage of limited accessibility for general users.

Accordingly, the technology that allows even users having low prompt writing capabilities to modify the prompt into the desired form with simple gestures and set the parameters or conditions for answers generated by generative AI is required.

### RELATED ART DOCUMENTS

### Patent Document

(Patent Document 1) Korean Patent Laid-Open Publication No. 10-2019-0114410 (published on Oct. 10, 2019)

### SUMMARY

Aspects of the present disclosure provide a method and system that allows a user having low prompting capabilities to modify a prompt with only simple gesture input.

Aspects of the present disclosure also provide a method and system that allows a user having low prompting capabilities to set generation conditions for answers generated by generative AI with only simple gesture input.

Aspects of the present disclosure also provide a method and system capable of searching for prompts written by a user in the past or answers generated by generative AI in the past, with only simple gesture input.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for modifying a prompt, performed by a computing device. The method may comprise displaying a first prompt written by a user in a prompt input area of an answer generation screen displayed on the computing device, replacing a keyboard display area with a prompt modification area and displaying the prompt modification area, in response to a predefined first gesture within the keyboard display area of the answer generation screen, and displaying a second prompt in which the first prompt is modified in the prompt input area, in response to a second gesture for modifying the prompt.

In some embodiments, the first gesture includes a simultaneous input of a first long-tap input and a second long-tap of the user.

In some embodiments, the second gesture is performed while maintaining a first touch input and a second touch input of the user within the prompt modification area, and the second prompt is modified based on a distance between a location where the first touch input is detected and a location where the second touch input is detected.

In some embodiments, a length of the second prompt is proportional to the distance between the location where the first touch input is detected and the location where the second touch input is detected.

In some embodiments, the method may further comprise transmitting the second prompt to a Large Language Mode (LLM), in response to at least one of the first touch input and the second touch input to the prompt modification area being terminated.

In some embodiments, the method may further comprise replacing the prompt modification area with a condition setting area for generating an answer and displaying the condition setting area, in response to a third gesture within the prompt modification area, receiving setting information for one or more conditions for generating an answer to the second prompt, in response to a fourth gesture within the condition setting area; and displaying a guide prompt matching the setting information in an area adjacent to the condition setting area.

In some embodiments, the second gesture is performed in a first direction while maintaining a first touch input and a second touch input of the user within the prompt modification area, and the fourth gesture is performed in a second direction substantially perpendicular to the first direction while maintaining the first touch input and the second touch input.

In some embodiments, a first condition for generating the answer to the second prompt is diversity of an answer, and the fourth gesture includes an action of locating the first touch input in an area where an object representing the diversity of the answer is displayed, and moving the second touch input in the second direction.

In some embodiments, a second condition for generating the answer to the second prompt is token usage, and the fourth gesture includes an action of locating the first touch input in an area where an object representing the token usage is displayed, and moving the second touch input in the second direction.

In some embodiments, a third condition for generating the answer to the second prompt is a number of queries, and the fourth gesture includes an action of locating the first touch input in an area where an object representing the number of queries is displayed, and moving the second touch input in the second direction.

In some embodiments, the method may further comprise transmitting the second prompt the guide prompt to a Large Language Mode (LLM), in response to at least one of the first touch input and the second touch input to the condition setting area being terminated.

According to another aspect of the present disclosure, there is provided a method for modifying a prompt, performed by a computing device. The method may comprise displaying a keyboard display area and a question and answer display area, replacing the keyboard display area with a question and answer history search area and displaying the question and answer history search area, in response to a predefined first gesture within the keyboard display area, the first gesture including a simultaneous input of a first touch input and a second touch input, displaying a plurality of graphic objects within the question and answer history search area, in response to a change in a location where the input of the first gesture is detected, and displaying question and answer history data corresponding to each graphic object in which a touch input is detected in the question and answer display area, in response to a second gesture including the touch input to at least one of the plurality of graphic objects.

In some embodiments, the second gesture is continuously performed while maintaining the input of the first gesture.

In some embodiments, the question and answer history data includes answer history data generated by a Large Language Model (LLM) and prompt history data written by a user.

In some embodiments, the plurality of graphic objects are point-shaped graphic objects continuously arranged in a first direction, the second gesture includes an action of locating the second touch input in an area where a first graphic object is displayed while maintaining the first touch input, and locating the second touch input in an area where a second graphic object is displayed by moving the second touch input in the first direction, and the question and answer history data is answer history data generated by a Large Language Model (LLM).

In some embodiments, the second gesture further includes an action of locating the first touch input in an area where the first graphic object is displayed while maintaining the second touch input, and locating the first touch input in an area where the second graphic object is displayed by moving the first touch input in the first direction, and the question and answer history data is prompt history data written by a user

In some embodiments, the displaying of the question and answer history data in the question and answer display area further includes receiving selection option information for the question and answer history data in response to a third gesture within the question and answer history search area, and displaying the question and answer history data in the question and answer display area based on the selection option information, and the third gesture includes an action of moving the first touch input in a direction substantially perpendicular to the first direction while maintaining the second touch input.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a flowchart illustrating a method for modifying a prompt according to an embodiment of the present disclosure;

FIGS. 2 and 3 are exemplary diagrams for describing some of the operations illustrated in FIG. 2;

FIG. 4 is a flowchart illustrating a method for modifying a prompt that may be additionally performed in the process illustrated in FIG. 1;

FIGS. 5 to 7 are exemplary diagrams for describing some of the operations illustrated in FIG. 4;

FIG. 8 is a flowchart illustrating a method for modifying a prompt according to another embodiment of the present disclosure;

FIGS. 9 to 11 are exemplary diagrams for describing some of the operations illustrated in FIG. 8; and

FIG. 12 is a hardware configuration diagram of a system for modifying a prompt according to some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

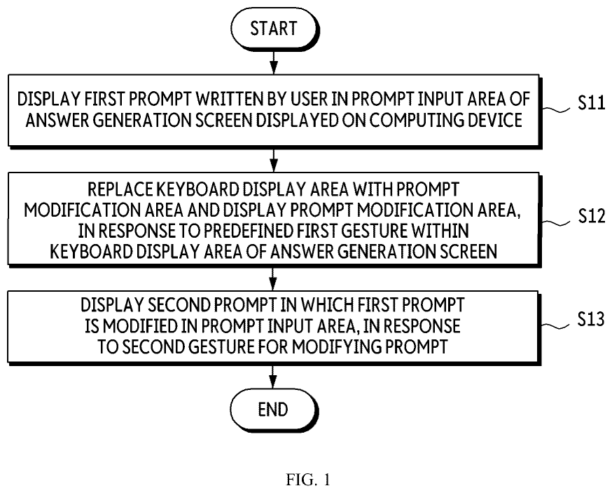

FIG. 1 is a flowchart illustrating a method for modifying a prompt according to an embodiment of the present disclosure. However, this is only a preferred embodiment for achieving the object of the present disclosure, and some steps may also be added or deleted as needed.

For reference, FIG. 1 illustrates steps/operations of a method performed by a user terminal (i.e., a computing device). Therefore, in the following descriptions, when the subject of a specific step/operation is omitted, it may be understood that the specific step/operation is performed by the user terminal.

For example, the user terminal may be a device such as a mobile phone, a smartphone, a tablet, a laptop PC, or a desktop PC. In the following, for the convenience of understanding, it is assumed that the user terminal is a smartphone and that a plurality of screens provided to the user are screens of the smartphone.

As illustrated in FIG. 1, a method for modifying a prompt according to an embodiment of the present disclosure may start at step S11 where a computing device (i.e., a user terminal) displays a first prompt written by a user in a prompt input area of an answer generation screen displayed on the computing device. For example, the user may input a prompt of text through a keyboard display area displayed on the screen of the computing device, and the prompt input by the user may be displayed in the prompt input area of the answer generation screen displayed on the user terminal.

In step S12, the computing device (i.e., user terminal) may replace the keyboard display area with a prompt modification area and display the keyboard display area, in response to a predefined first gesture of the user within the keyboard display area of the answer generation screen. In this case, the first gesture may include a simultaneous input of a first long-tap input and a second long-tap input by the user. In addition, the prompt modification area may refer to an area where the user may modify a previously input prompt through a gesture using an input means such as a finger or a touch pen.

For example, when the user simultaneously performs a first long-tap input using the fingers of the left hand and a second long-tap input using the fingers of the right hand within the keyboard display area, the keyboard display area may be replaced with the prompt modification area and displayed.

However, the above is only an example, and the type of the first gesture is not necessarily limited to such an example. That is, the first gesture may be a simultaneous long-tap input using two fingers of the right hand, or a simultaneous long-tap input using a plurality of touch pens. In addition, it should be noted that the example does not necessarily require two long-tap inputs to occur simultaneously. That is, even when the user terminal detects the first long-tap input and the second long-tap input within a certain period of time, the keyboard display area may be replaced with the prompt modification area and displayed.

In step S13, the computing device (i.e., user terminal) may display a second prompt with the first prompt modified in the prompt input area, in response to a second gesture for prompt modification.

In this case, the second gesture may be performed while maintaining a first touch input and a second touch input of the user within the prompt modification area. In addition, the second prompt may be modified based on a distance between a location where the first touch input is detected and a location where the second touch input is detected.

More specifically, the second gesture may be continuously performed while maintaining the input of the first gesture. That is, the operations illustrated in FIG. 1 may be based on gestures performed while an initial touch input of the user for the screen of the user terminal is maintained.

In addition, a length of the second prompt may be proportional to the distance between the location where the first touch input is detected and the location where the second touch input is detected. That is, as the distance between the location where the first touch input is detected and the location where the second touch input is detected increases, the length of the second prompt may increase, and as the distance between the location where the first touch input is detected and the location where the second touch input is detected decreases, the length of the second prompt may be reduced.

In some embodiments, guide text (e.g., “Improve the content by increasing the length of the prompt”) related to generating the second prompt by modifying the length of the first prompt according to the second gesture may be displayed on the screen of the user terminal together with the second prompt.

Although not illustrated in FIG. 1, the method for modifying the prompt according to the embodiment may further include, after the step S13 of displaying the second prompt with the first prompt modified in the prompt input area, a step of transmitting the second prompt to a Large Language Mode (LLM), in response to at least one of the first touch input and the second touch input to the prompt modification area being terminated.

That is, the operations illustrated in FIG. 1 are based on the first gesture and the second gesture performed while a plurality of touch inputs to the screen of the user terminal are continuously maintained, and when at least one of the plurality of touch inputs is terminated, a prompt displayed on the screen at the terminated time may be transmitted to the LLM.

In summary, the length of the prompt written by the user may increase or decrease through simple gesture input from the user. Accordingly, as the prompt is augmented to the extent desired by the user through the simple gesture input, prompting capabilities of the user may be supplemented and the quality or accuracy of a generated answer may be improved. In addition, convenience and satisfaction of the user may be improved.

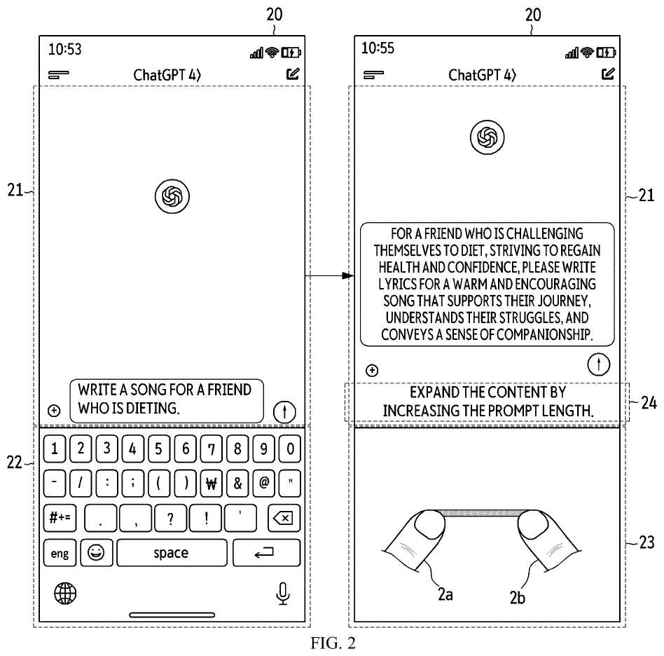

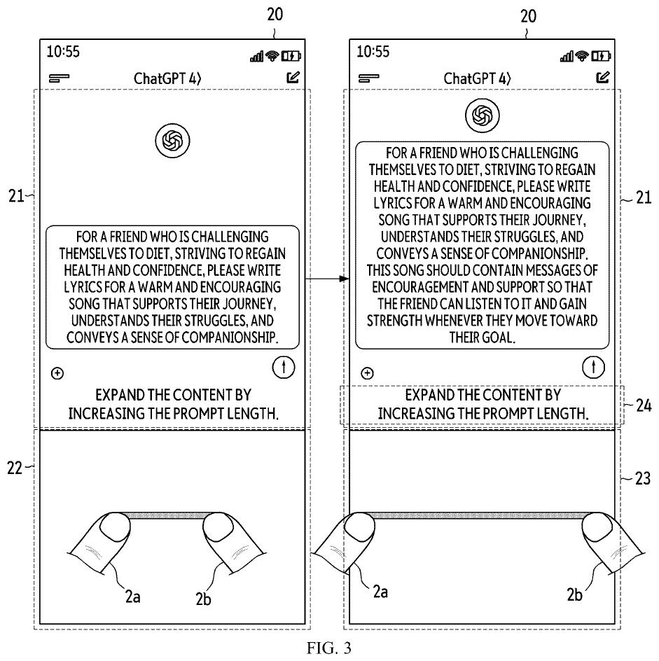

Hereinafter, some of the operations illustrated in FIG. 1 will be described with reference to FIGS. 2 and 3. The process illustrated in FIG. 1 may be clearly understood with reference to FIGS. 2 and 3.

FIGS. 2 and 3 are exemplary diagrams for describing some of the operations illustrated in FIG. 2. More specifically, FIGS. 2 and 3 are exemplary diagrams for describing an operation in which the keyboard display area is switched to the prompt modification area in response to the first gesture by the user, and the prompt written by the user is modified in response to the second gesture by the user.

As illustrated in FIG. 2, an answer generation screen 20 of the user terminal may include a prompt input area 21 and a keyboard display area 22. In this case, when the user inputs a predefined first gesture (e.g., simultaneous long-tap input using two fingers) within the keyboard display area 22, the keyboard display area 22 may be replaced with the prompt modification area 23 and displayed. In addition, guide text 24 related to the generation of the prompt may be displayed together in an area adjacent to the prompt modification area 23.

That is, when the user inputs a prompt to the keyboard display area 22 and simultaneously performs a touch input with two fingers within the keyboard display area 22 and then maintains the touch input for a certain period of time, the keyboard display area 22 may be switched to the prompt modification area 23. In this case, for the user's convenience, one touch input may be performed with either finger of the left hand, and the other touch input may be performed with either finger of the right hand.

As illustrated in FIG. 3, while a first touch input 2a and a second touch input 2b are maintained within the prompt modification area 23, the prompt displayed in the prompt input area 21 may be modified by changing a distance between the first touch input 2a and the second touch input 2b.

For example, when the distance between the first touch input 2a and the second touch input 2b increases, the prompt may be displayed by modifying the length of the first prompt displayed in the prompt input area 21 to a second prompt that is increased in proportion to the increased distance.

Similarly, when the distance between the first touch input 2a and the second touch input 2b decreases, the prompt may be displayed by modifying the length of the first prompt displayed in the prompt input area 21 to a second prompt that is decreased in proportion to the decreased distance.

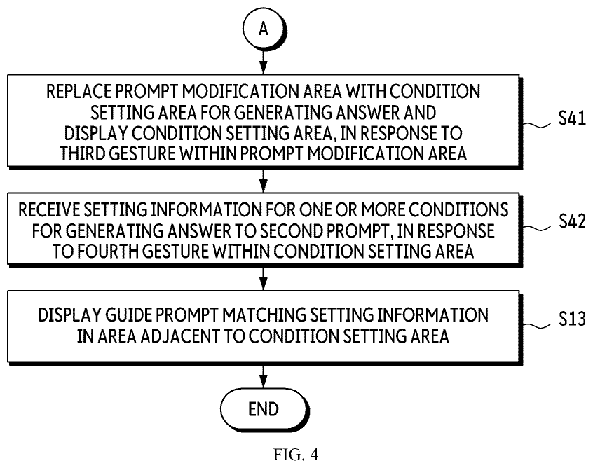

FIG. 4 is a flowchart illustrating a method for modifying a prompt that may be additionally performed in the process illustrated in FIG. 1. However, this is only a preferred embodiment for achieving the object of the present disclosure, and some steps may also be added or deleted as needed.

For reference, FIG. 4 illustrates steps/operations of a method performed by a user terminal (i.e., a computing device). Therefore, in the following descriptions, when the subject of a specific step/operation is omitted, it may be understood that the specific step/operation is performed by the user terminal.

As illustrated in FIG. 4, after the step S13 illustrated in FIG. 1 is performed, a step S41 may be performed in which a computing device (i.e., a user terminal) replaces the prompt modification area with a condition setting area for generating an answer and displays the condition setting area, in response to a third gesture within the prompt modification area.

In this case, the third gesture may refer to moving either the first touch input or the second touch input in a vertical direction while maintaining the input of the second gesture. That is, as illustrated in FIGS. 2 and 3, the movement of the first touch input and the second touch input included in the second gesture may be performed in a horizontal direction, but the third gesture may be performed in the vertical direction. When the movement in the vertical direction is firstly detected in the movement of the first and second touch inputs performed in the horizontal direction, the computing device (i.e., user terminal) may replace the prompt modification area with the condition setting area for generating an answer and display the condition setting area.

In step S42, the computing device (i.e., user terminal) may receive setting information for one or more conditions for generating an answer to the second prompt in response to a fourth gesture within the condition setting area.

In this case, the second gesture may be performed in a first direction while maintaining the first touch input and the second touch input of the user within the prompt modification area, and the fourth gesture may be performed in a second direction substantially perpendicular to the first direction while maintaining the first touch input and the second touch input. That is, as illustrated in FIGS. 2 and 3, the second gesture may be performed in the first direction (e.g., the horizontal direction), while the fourth gesture may be performed in the second direction (e.g., the vertical direction) substantially perpendicular to the first direction.

In an embodiment, a first condition for generating an answer to the second prompt may be diversity of an answer, and the fourth gesture may include an action of locating the first touch input in an area where an object representing the diversity of the answer is displayed, and moving the second touch input in the second direction.

That is, the user may select a first condition for setting the diversity of the answer among the plurality of conditions for generating the answer to the second prompt by moving the first touch input using the left hand, and may determine the degree of diversity of the answer (e.g., high, medium, and low) by moving the second touch input using the right hand.

In an embodiment, a second condition for generating an answer to the second prompt may be token usage, and the fourth gesture may include an action of locating the first touch input in an area where an object representing the token usage is displayed, and moving the second touch input in the second direction.

That is, the user may select a second condition for setting the token usage among the plurality of conditions for generating the answer to the second prompt by moving the first touch input using the left hand, and may determine the degree of token usage (e.g., high, medium, and low) by moving the second touch input using the right hand.

In an embodiment, a third condition for generating an answer to the second prompt may be the number of queries, and the fourth gesture may include an action of locating the first touch input in an area where an object representing the number of queries is displayed, and moving the second touch input in the second direction.

That is, the user may select a second condition for setting the number of queries among the plurality of conditions for generating the answer to the second prompt by moving the first touch input using the left hand, and may determine the degree of the number of queries (e.g., 5 times, 10 times, 15 times, and 20 times) by moving the second touch input using the right hand.

However, it should be noted that the conditions for generating the answer to the prompt that the user may set via the fourth gesture within the condition setting area displayed on the answer generation screen are not limited to the examples described above. That is, various conditions related to prompt engineering techniques for generating optimal answers may be set, such as a condition (i.e., the degree of unpredictability) for determining a probability distribution of words to be generated, a condition for avoiding generation of duplicate words, etc.

Referring again to FIG. 4, in step S43, the computing device (i.e., user terminal) may display a guide prompt matching the setting information received through the step S42 in an area adjacent to the condition setting area.

Specifically, a guide prompt including setting information for each of the plurality of conditions input by the user to generate the optimal answer may be displayed in the area adjacent to the condition setting area. In this case, the setting information for each condition may be displayed so as to be visually distinguished from each other.

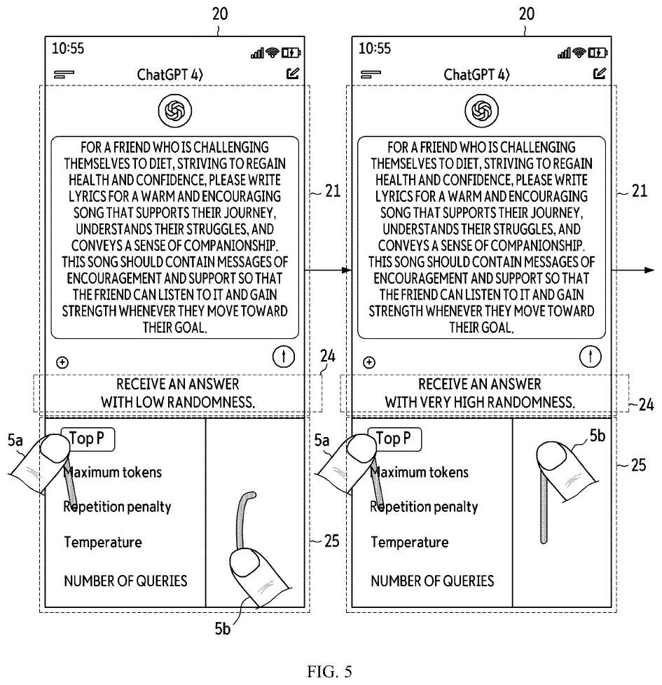

A more detailed description of the process illustrated in FIG. 4 will be described later with reference to FIGS. 5 to 7.

Although not illustrated in FIG. 4, the method for modifying the prompt according to the embodiment may further include, after the step S43 of displaying the guide prompt matching the setting information in the area adjacent to the condition setting area is performed, a step of transmitting the second prompt and the guide prompt to a Large Language Mode (LLM), in response to at least one of the first touch input and the second touch input to the condition setting area being terminated.

That is, the operations illustrated in FIG. 4 are based on the third gesture and the fourth gesture performed while a plurality of touch inputs to the screen of the user terminal are continuously maintained, and when at least one of the plurality of touch inputs is terminated, a prompt displayed on the screen at the terminated time may be transmitted to the LLM.

In some embodiments, the process illustrated in FIG. 4 may not be performed after the process illustrated in FIG. 1 is completed. That is, the operations illustrated in FIG. 4 may be performed independently after the user inputs/writes the prompt through the keyboard display area, rather than being performed after the user modifies the prompt by adjusting the distance between the two fingers.

For example, when the user inputs a predefined gesture (e.g., simultaneously performing the first long-tap input using the finger of the left hand and the second long-tap input using the finger of the right hand, simultaneous double-tap input using two fingers) to the keyboard display area, after inputting the prompt for generating the answer through the keyboard display area, the keyboard display area may be replaced with the condition setting area and displayed. Thereafter, one or more conditions for generating an answer may be set in response to a gesture of the user to the condition setting area, as in the operations illustrated in FIG. 4.

In summary, the parameters or conditions of the answer to be generated by the LLM may be set based on the prompt written by the user through a simple gesture input from the user. Accordingly, an optimal answer that meets the needs of the user may be generated, and user convenience, satisfaction, and usability may be increased.

Hereinafter, some of the operations illustrated in FIG. 4 will be described with reference to FIGS. 5 to 7. The process illustrated in FIG. 4 may be clearly understood with reference to FIGS. 5 to 7.

FIGS. 5 to 7 are exemplary diagrams for describing some of the operations illustrated in FIG. 4. More specifically, FIGS. 5 to 7 are exemplary diagrams for describing a process for setting various answer generation conditions to obtain an optimal answer to a prompt written by the user.

As illustrated in FIG. 5, a condition setting area 25 of the answer generation screen 20 may be displayed through a predefined third gesture for the prompt modification area 23 illustrated in FIG. 2. In addition, the condition setting area 25 may be displayed through a predefined gesture for the keyboard display area 22 illustrated in FIG. 2. Since a detailed description thereof has been provided with reference to FIG. 4, the description of overlapping content will be omitted.

The user may select a first condition (i.e., Top P (randomness of answer)) among a plurality of conditions (e.g., “Top P”, “Maximum tokens”, “Repetition penalty”, “Temperature”, “Number of queries”) displayed in the condition setting area 25 by moving a first touch input 5a in the vertical direction. Thereafter, the user may set the degree of the selected first condition (i.e., Top P (randomness of the answer)) by moving a second touch input 5b in the vertical direction. More specifically, as illustrated in FIG. 5, the user may set an answer with low randomness to be generated by moving the second touch input 5b in a downward direction, and may set an answer with high randomness to be generated by moving the second touch input 5b in an upward direction. In this case, the guide prompt 24 including setting information for the first condition may be displayed in an area adjacent to the condition setting area 25.

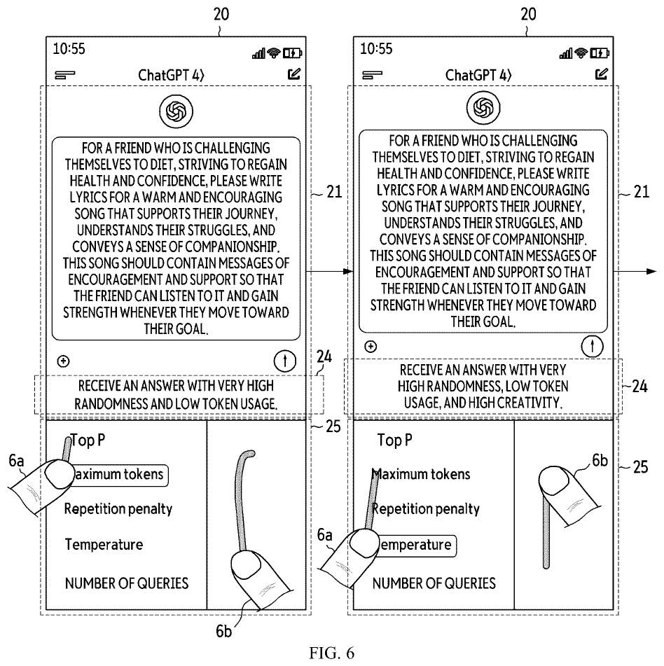

Referring to FIG. 6, after completing the setting for the first condition, the user may also input settings for a second condition that is different from the first condition by inputting a gesture to the condition setting area.

As illustrated in FIG. 6, the user may select a second condition (i.e., Maximum tokens (token usage)) among the plurality of conditions (e.g., “Top P”, “Maximum tokens”, “Repetition penalty”, “Temperature”, “Number of queries”) displayed in the condition setting area 25 by moving a first touch input 6a in the downward direction. Thereafter, the user may set the degree of the selected second condition (i.e., Maximum tokens (token usage)) by moving a second touch input 6b in the vertical direction. More specifically, as illustrated in FIG. 6, the user may set an answer with low token usage to be generated by moving the second touch input 6b in the downward direction, and may set an answer with high token usage to be generated by moving the second touch input 6b in the upward direction. In this case, the guide prompt 24 including setting information for the second condition may be displayed in an area adjacent to the condition setting area 25.

Similarly, the user may select a third condition (i.e., Temperature (unpredictability, creativity)) among the plurality of conditions (e.g., “Top P”, “Maximum tokens”, “Repetition penalty”, “Temperature”, “Number of queries”) displayed in the condition setting area 25 by moving the first touch input 6a in the downward direction. Thereafter, the user may set the degree of the selected third condition (i.e., Temperature (unpredictability, creativity)) by moving the second touch input 6b in the vertical direction. More specifically, as illustrated in FIG. 6, the user may set an answer with high creativity to be generated by moving the second touch input 6b in the upward direction, and may set an answer with low creativity to be generated by moving the second touch input 6b in the downward direction. In this case, the guide prompt 24 including setting information for the third condition may be displayed in an area adjacent to the condition setting area 25.

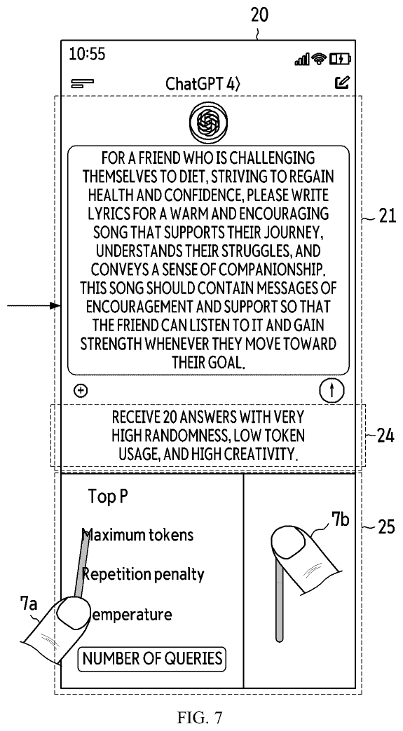

Furthermore, as illustrated in FIG. 7, the user may select a fourth condition (i.e., Number of queries) among the plurality of conditions (e.g., “Top P”, “Maximum tokens”, “Repetition penalty”, “Temperature”, “Number of queries”) displayed in the condition setting area 25 by moving a first touch input 7a in the downward direction. Thereafter, the user may set the degree of the selected fourth condition (i.e., Number of queries) by moving a second touch input 7b in the vertical direction. More specifically, as illustrated in FIG. 7, the user may set a desired number of answers to be generated by moving the second touch input 7b in the vertical direction and setting a specific number of queries (e.g., 20 times). In this case, the guide prompt 24 including setting information for the fourth condition may be displayed in an area adjacent to the condition setting area 25.

As illustrated in FIGS. 5 to 7, the condition setting area displayed on the screen of the user terminal may be displayed differently at each time the plurality of conditions are set to generate the optimal answer. That is, the condition setting area displayed when setting the first condition and the condition setting area displayed when setting the second condition may be displayed so as to be visually distinct. Accordingly, when the user sets the plurality of conditions, each condition may be displayed so as to be visually distinct, making it easy to understand information about how each condition was set, and increasing usability.

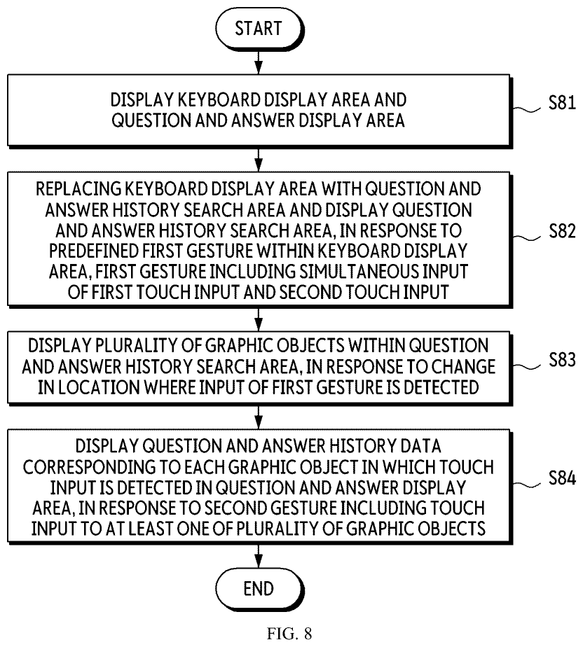

So far, the method for modifying the prompt according to the embodiment of the present disclosure has been described with reference to FIGS. 1 to 7. The content described with reference to FIGS. 1 to 7 may be understood as a process performed after the user writes the prompt through the keyboard display area. However, in some cases, there may be cases where the user wants to load history data of a previously written prompt or write a prompt by referring to answer history data generated by the LLM, before writing the prompt through the keyboard display area. Hereinafter, a process that may be performed when the user does not input/write the prompt through the keyboard display area will be described with reference to FIGS. 8 to 11.

FIG. 8 is a flowchart illustrating a method for modifying a prompt according to another embodiment of the present disclosure. However, this is only a preferred embodiment for achieving the object of the present disclosure, and some steps may also be added or deleted as needed.

For reference, FIG. 8 illustrates steps/operations of a method performed by a user terminal (i.e., a computing device). Therefore, in the following descriptions, when the subject of a specific step/operation is omitted, it may be understood that the specific step/operation is performed by the user terminal.

As illustrated in FIG. 8, a method for modifying a prompt according to an embodiment of the present disclosure may start at step S81, where a computing device (i.e., a user terminal) displays a keyboard display area and a question and answer display area. In this case, the question and answer display area is an area where question and answer history data is displayed, and the question and answer history data may include answer history data generated by the LLM and prompt history data written by the user.

In step S82, the computing device (i.e., user terminal) may replace the keyboard display area with a question and answer history search area and display the question and answer history search area, in response to a predefined first gesture within the keyboard display area. In this case, the first gesture may include a simultaneous input of a first touch input and a second touch input. For example, when a first touch input using either finger of the left hand and a second touch input using either finger of the right hand are simultaneously detected within the keyboard display area, the user terminal may replace the keyboard display area with the question and answer history search area and display the question and answer history search area. Thereafter, the user may search answer history data generated by the LLM or prompt history data written by the user through a gesture input within the question and answer history search area.

In step S83, the computing device (i.e., user terminal) may display a plurality of graphic objects within the question and answer history search area in response to a change in a location where the input of the first gesture is detected. In this case, the plurality of graphic objects may be point-shaped graphic objects continuously arranged in the first direction.

In step S84, the computing device (i.e., user terminal) may display question and answer history data corresponding to each graphic object in which a touch input is detected in the question and answer display area, in response to a second gesture including the touch input to at least one of the plurality of graphic objects. In this case, the second gesture may be continuously performed while maintaining the input of the first gesture. That is, the second gesture may be performed while the first touch input and the second touch input included in the first gesture are continuously maintained.

In addition, the second gesture may include a first action of locating the second touch input in an area where a first graphic object is displayed while maintaining the first touch input, and locating the second touch input in an area where a second graphic object is displayed by moving the second touch input in the first direction. In response to the first action, answer history data generated by a Large Language Model (LLM) corresponding to the graphic object where the second touch input is located may be displayed in the question and answer display area.

Conversely, the second gesture may include a second action of locating the first touch input in an area where a first graphic object is displayed while maintaining the second touch input, and locating the first touch input in an area where a second graphic object is displayed by moving the first touch input in the first direction. In response to the second action, prompt history data written by the user corresponding to the graphic object where the second touch input is located may be displayed in the question and answer display area.

That is, when the touch input using the right finger is fixed and the touch input using the left finger is moved in the direction where the graphic object is located, the answer history data generated by the LLM may be displayed in the question and answer display area, and when the touch input using the left finger is fixed and the touch input using the right finger is moved in the direction where the graphic object is located, the prompt history data written by the user may be displayed in the question and answer display area.

In some embodiments, the step S84 of displaying the question and answer history data in the question and answer display area may further include a step of the computing device (i.e., the user terminal) receiving selection option information for the question and answer history data in response to a third gesture within the question and answer history search area, and displaying the question and answer history data in the question and answer display area based on the selection option information. In this case, the third gesture may include an action of moving the first touch input in a direction substantially perpendicular to the first direction while maintaining the second touch input.

That is, the user may determine selection options for the question and answer history data currently displayed in the question and answer display area through the third gesture, when the user moves the touch input to a desired location of the graphic object through the second gesture, and the question and answer history data corresponding to the graphic object is displayed in the question and answer display area. In this case, the selection options may include deletion and selection (e.g., answer recombination, answer reinforcement).

In summary, the prompts written by the user in the past or the answers generated in the past by the LLM may be easily searched through a simple gesture input of the user. Accordingly, past question and answer history data may be easily and quickly searched, and user convenience, satisfaction, and usability may be improved.

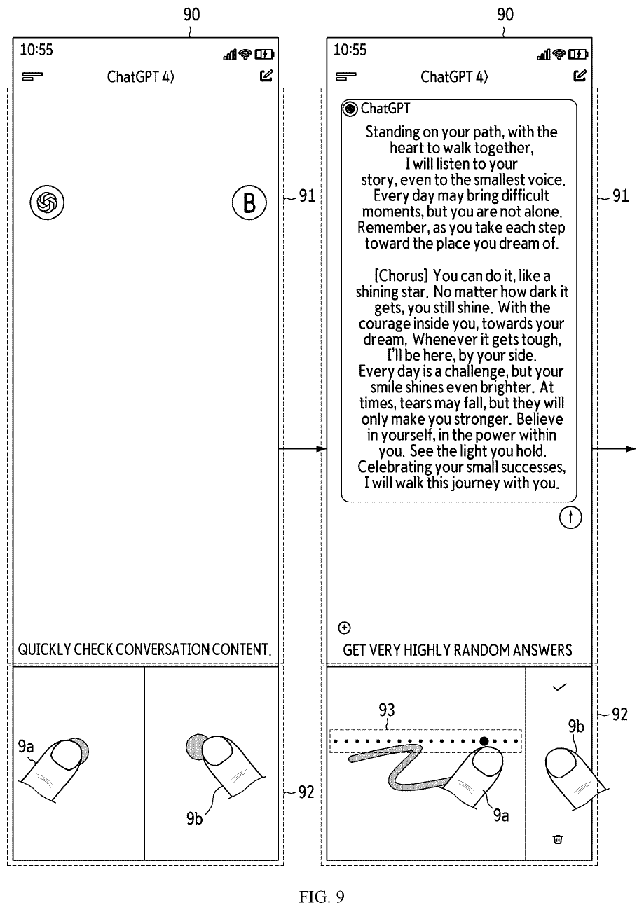

FIGS. 9 to 11 are exemplary diagrams for describing some of the operations illustrated in FIG. 8. More specifically, FIGS. 9 to 11 are exemplary diagrams for describing a search process for obtaining a prompt written by the user or an answer generated by the LLM.

As illustrated in FIG. 9, a question and answer history search area 92 of an answer generation screen 90 may be displayed through a predefined first gesture for the keyboard display area 22 illustrated in FIG. 2. Since the detailed description of the first gesture and the switching of the area display according to the first gesture has been described above with reference to FIG. 4, a description of the overlapping content will be omitted.

After a first gesture including a simultaneous input of a first touch input 9a and a second touch input 9b is input, when a change in an input location of either the first touch input 9a or the second touch input 9b is detected, the user terminal may display a plurality of graphic objects 93 within the question and answer history search area 92. In this case, the plurality of graphic objects 93 may mean point-shaped objects that are consecutively arranged in the horizontal direction, as illustrated in FIG. 9. In addition, the first touch input 9a may be an input using either finger of the left hand, and the second touch input 9b may be an input using either finger of the right hand.

The user may select the plurality of graphic objects by moving the first touch input 9a in the horizontal direction while maintaining the second touch input 9b. In addition, the user may select the plurality of graphic objects by moving the second touch input 9b in the horizontal direction while maintaining the first touch input 9a. During the movement process, question and answer history data corresponding to the graphic object where the second touch input 9b is located may be displayed in the question and answer display area 91.

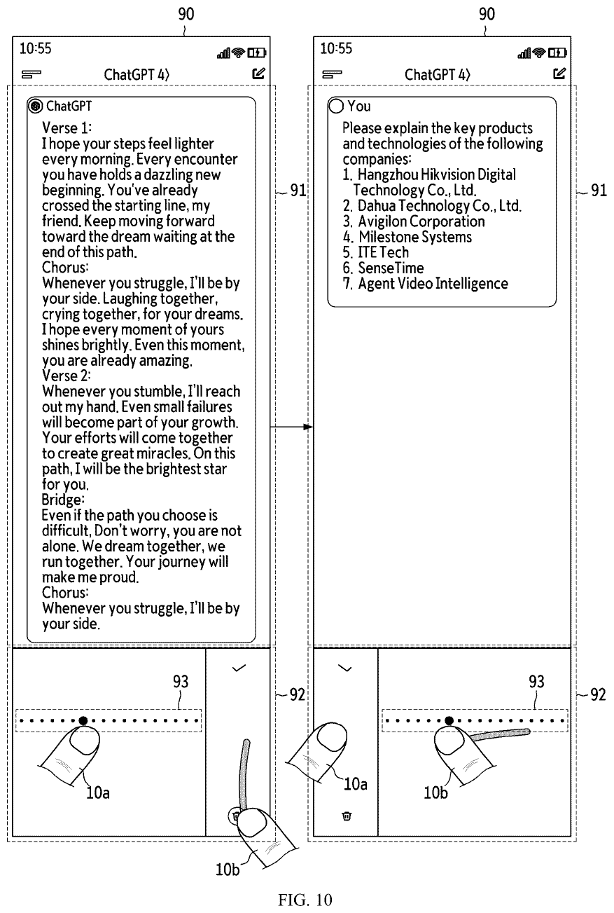

More specifically, as illustrated in FIGS. 9 and 10, the user may sequentially search the answer history data generated by the LLM by moving the first touch input 9a to the right while maintaining the second touch input 9b, and may sequentially search the prompt history data input/written by the user by moving the second touch input 9b in the horizontal direction while maintaining the first touch input 9a.

After the user completes the search for the desired question and answer history data via the gesture described above, the user may select an option of deleting the searched question and answer history data or generating a prompt based on the searched question and answer history data.

For example, as illustrated in FIG. 10, after the user searches for a desired question and answer history data by moving a first touch input 10a, the user may delete the searched question and answer history data by moving a second touch input 10b in a downward direction. More specifically, when the user moves the second touch input 10b to a third graphic object 10c expressing data deletion, the question and answer history data displayed in the question and answer display area 91 may be deleted.

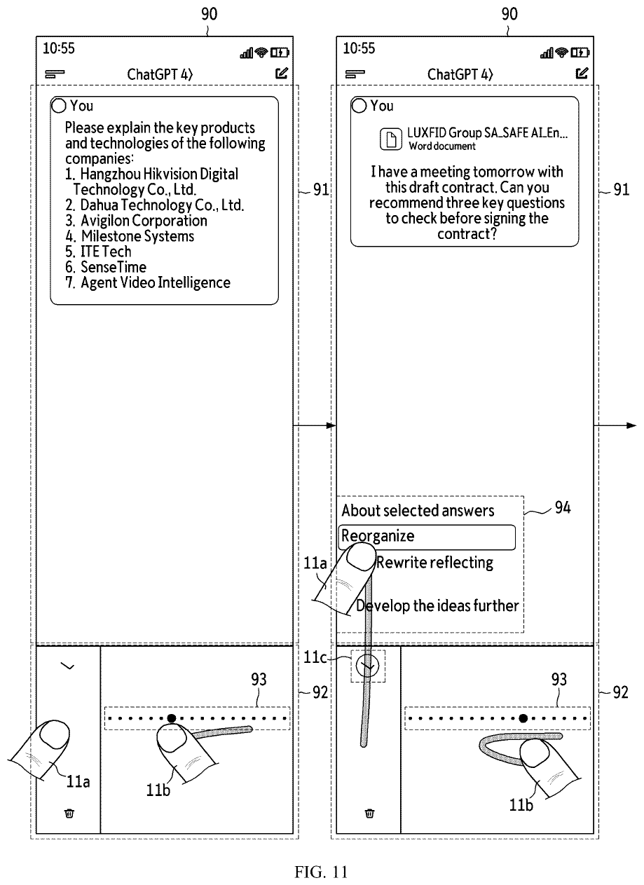

In addition, as illustrated in FIG. 11, after the user searches for a desired question and answer history data by moving a second touch input 11b, the user may select a prompt generation option for the searched question and answer history data by moving a first touch input 11a in an upward direction. More specifically, when the user moves the first touch input 11a to a fourth graphic object 11c expressing option selection, an option selection window 94 may be displayed in an area adjacent to the fourth graphic object 11c. Thereafter, the user may select options (e.g., recombination, reflection and newly writing, reinforcement (development), etc.) displayed in the option selection window 94.

So far, the method for modifying the prompt according to some embodiments of the present disclosure has been described with reference to FIGS. 1 to 8. According to the method for modifying the prompt according to some embodiments of the present disclosure, augmentation of the prompt written by the user, generation of the parameters or conditions for answer generation, and search of past question and answer history data may be easily and quickly performed through simple gesture input of the user.

Accordingly, the cost or time spent by the user with low prompting capabilities on augmenting prompts, setting parameters or conditions for generating answers, and searching past question and answer history data may be effectively reduced. In addition, convenience, satisfaction, and usability of the user may be improved.

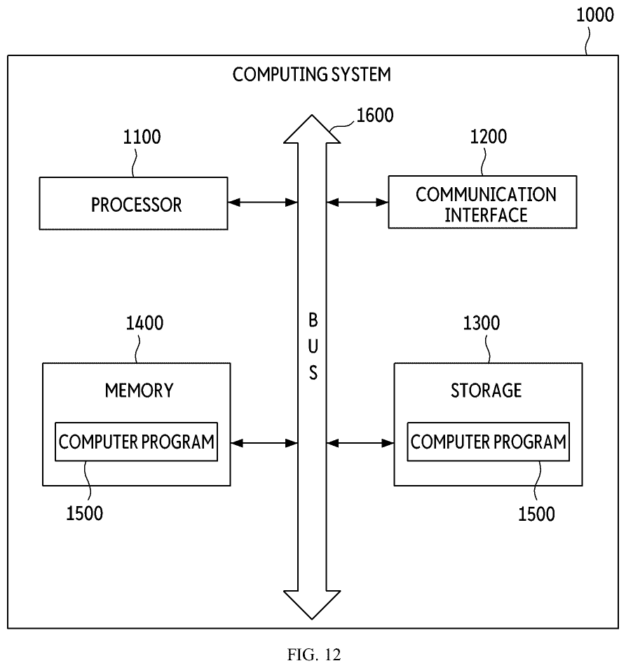

FIG. 12 is a hardware configuration diagram of a system for modifying a prompt according to some embodiments of the present disclosure. A system 1000 for modifying a prompt illustrated in FIG. 12 may include one or more processors 1100, a system bus 1600, a communication interface 1200, a memory 1400 for loading a computer program 1500 executed by the processor 1100, and a storage 1300 for storing the computer program 1500.

The processor 1100 controls the overall operation of each component of the system 1000 for modifying the prompt. The processor 1100 may perform a calculation on at least one application or program for executing the methods/operations according to various exemplary embodiments of the present disclosure. The memory 1400 stores various data, commands, and/or information. The memory 1400 may load one or more programs 1500 from the storage 1300 to execute the methods/operations according to various embodiments of the present disclosure. The system bus 1600 provides a communication function between components of the system 1000 for modifying the prompt. The communication interface 1200 supports Internet communication of the system 1000 for modifying the prompt. The storage 1300 may non-temporarily store one or more computer programs 1500. The computer program 1500 may include one or more instructions in which the methods/operations according to various embodiments of the present disclosure are implemented. When the computer program 1500 is loaded into the memory 1400, the processor 1100 may perform the methods/operations according to various embodiments of the present disclosure by executing the one or more instructions.

In some embodiments, the system 1000 for modifying the prompt described with reference to FIG. 12 may be configured using one or more physical servers included in a server farm based on a cloud technology such as a virtual machine. In this case, at least some of the processor 1100, the memory 1400, and the storage 1300 among the components illustrated in FIG. 12 may be virtual hardware, and the communication interface 1200 may also be implemented as a virtualized networking element such as a virtual switch.

So far, various embodiments of the present disclosure and effects according to the embodiments have been described with reference to FIGS. 1 to 12. The effects according to the technical idea of the present disclosure are not limited to the effects mentioned above, and other effects that are not mentioned may be obviously understood by those skilled in the art from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation. The scope of protection of the present invention should be interpreted in accordance with the claims below, and all technical ideas within the equivalent scope should be construed as being included in the scope of rights of the technical ideas defined by this disclosure.

What is claimed is:

1. A method for modifying a prompt, performed by a computing device, the method comprising:
displaying a first prompt written by a user in a prompt input area of an answer generation screen displayed on the computing device;
replacing a keyboard display area with a prompt modification area and displaying the prompt modification area, in response to a predefined first gesture within the keyboard display area of the answer generation screen; and
displaying a second prompt in which the first prompt is modified in the prompt input area, in response to a second gesture for modifying the prompt.

2. The method of claim 1, wherein the first gesture includes a simultaneous input of a first long-tap input and a second long-tap of the user.

3. The method of claim 1, wherein the second gesture is performed while maintaining a first touch input and a second touch input of the user within the prompt modification area, and
the second prompt is modified based on a distance between a location where the first touch input is detected and a location where the second touch input is detected.

4. The method of claim 3, wherein a length of the second prompt is proportional to the distance between the location where the first touch input is detected and the location where the second touch input is detected.

5. The method of claim 3, further comprising transmitting the second prompt to a Large Language Mode (LLM), in response to at least one of the first touch input and the second touch input to the prompt modification area being terminated.

6. The method of claim 1, further comprising:
replacing the prompt modification area with a condition setting area for generating an answer and displaying the condition setting area, in response to a third gesture within the prompt modification area;
receiving setting information for one or more conditions for generating an answer to the second prompt, in response to a fourth gesture within the condition setting area; and
displaying a guide prompt matching the setting information in an area adjacent to the condition setting area.

7. The method of claim 6, wherein the second gesture is performed in a first direction while maintaining a first touch input and a second touch input of the user within the prompt modification area, and
the fourth gesture is performed in a second direction substantially perpendicular to the first direction while maintaining the first touch input and the second touch input.

8. The method of claim 7, wherein a first condition for generating the answer to the second prompt is diversity of an answer, and
the fourth gesture includes an action of locating the first touch input in an area where an object representing the diversity of the answer is displayed, and moving the second touch input in the second direction.

9. The method of claim 7, wherein a second condition for generating the answer to the second prompt is token usage, and
the fourth gesture includes an action of locating the first touch input in an area where an object representing the token usage is displayed, and moving the second touch input in the second direction.

10. The method of claim 7, wherein a third condition for generating the answer to the second prompt is a number of queries, and
the fourth gesture includes an action of locating the first touch input in an area where an object representing the number of queries is displayed, and moving the second touch input in the second direction.

11. The method of claim 7, further comprising transmitting the second prompt the guide prompt to a Large Language Mode (LLM), in response to at least one of the first touch input and the second touch input to the condition setting area being terminated.

12. A method for modifying a prompt, performed by a computing device, the method comprising:
displaying a keyboard display area and a question and answer display area;
replacing the keyboard display area with a question and answer history search area and displaying the question and answer history search area, in response to a predefined first gesture within the keyboard display area, the first gesture including a simultaneous input of a first touch input and a second touch input;
displaying a plurality of graphic objects within the question and answer history search area, in response to a change in a location where the input of the first gesture is detected; and
displaying question and answer history data corresponding to each graphic object in which a touch input is detected in the question and answer display area, in response to a second gesture including the touch input to at least one of the plurality of graphic objects.

13. The method of claim 12, wherein the second gesture is continuously performed while maintaining the input of the first gesture.

14. The method of claim 12, wherein the question and answer history data includes answer history data generated by a Large Language Model (LLM) and prompt history data written by a user.

15. The method of claim 12, wherein the plurality of graphic objects are point-shaped graphic objects continuously arranged in a first direction,
the second gesture includes an action of locating the second touch input in an area where a first graphic object is displayed while maintaining the first touch input, and locating the second touch input in an area where a second graphic object is displayed by moving the second touch input in the first direction, and
the question and answer history data is answer history data generated by a Large Language Model (LLM).

16. The method of claim 15, wherein the second gesture further includes an action of locating the first touch input in an area where the first graphic object is displayed while maintaining the second touch input, and locating the first touch input in an area where the second graphic object is displayed by moving the first touch input in the first direction, and
the question and answer history data is prompt history data written by a user.

17. The method of claim 15, wherein the displaying of the question and answer history data in the question and answer display area further includes:
receiving selection option information for the question and answer history data in response to a third gesture within the question and answer history search area, and displaying the question and answer history data in the question and answer display area based on the selection option information, and
the third gesture includes an action of moving the first touch input in a direction substantially perpendicular to the first direction while maintaining the second touch input.
